(19) United States
(12) Patent Application Publication
(10) Pub. No.: US 2021/0381132 A1
(43) Pub. Date: Dec. 9, 2021

(54) TRANSITION METAL DICHALCOGENIDE FIBER AND METHOD OF PRODUCING THE SAME

(71) Applicant: KOREA ADVANCED INSTITUTE OF SCIENCE AND TECHNOLOGY, Daejeon (KR)

(72) Inventors: SangOuk KIM, Daejeon (KR); Taeyeong YUN, Daejeon (KR); Seong-jun JEONG, Gyeonggi-do (KR); Hoe Yeon LIM, Gyeonggi-do (KR); Simon KIM, Seoul (KR)

(21) Appl. No.: 17/319,615

(22) Filed: May 13, 2021

(30) Foreign Application Priority Data
May 14, 2020 (KR) 10-2020-0057485

(51) Int. Cl. D01F 8/18; D01D 5/06; D01F 9/08

(52) U.S. Cl. CPC D01F 8/18; D01F 9/08; D01D 5/06

(57) ABSTRACT

Provided is a method of producing a transition metal dichalcogenide fiber. The method of producing a transition metal dichalcogenide fiber according to the present invention includes: spinning a spinning solution containing a transition metal dichalcogenide in a coagulation solution to obtain a transition metal dichalcogenide fiber, wherein the spinning solution has liquid crystallinity by the transition metal dichalcogenide.

### CROSS-REFERENCE TO RELATED APPLICATIONS

This application claims priority under 35 U.S.C. § 119 to Korean Patent Application No. 10-2020-0057485, filed on May 14, 2020, in the Korean Intellectual Property Office, the disclosure of which is incorporated herein by reference in its entirety.

### TECHNICAL FIELD

The following disclosure relates to a transition metal dichalcogenide fiber and a method of producing the same, and in particular, to a transition metal dichalcogenide fiber which is a two-dimensional material and a method of producing the same.

### BACKGROUND

A mono-layered or few-layered transition metal dichalcogenide is a semiconductor material which has high electrical mobility, has an excellent on-off ratio, and has a direct electron band structure (direct transition type) unlike bulk (transition dichalcogen compound). In addition, since the mono-layered or few-layered transition metal dichalcogenide shows greatly improved photoluminescence (PL) efficiency together with a strong excitation effect, has magnetically and optically large anisotropy, and shows unique physical properties, it is an object of attention in various application fields ranging from catalysis to a sensing element, energy storage, and an optoelectronic element. In addition, since a transition metal dichalcogenide has a flexible property, it has an advantage suitable for use in a wearable element or a flexible element.

Meanwhile, a fiber-based wearable electronic element which is freely deformed and may be folded or bent like paper or rolled like a scroll, receives attention.

In line with the trend, development of technology for fine thread type flexible e-textile or e-fiber utilized in smart electronic clothing, a wearable computing device, a wearable display, a smart fabric, and the like is in demand.

However, the transition metal dichalcogenide has a weak interlayer Van der Waals interaction so that fibrosis showing the intrinsic physical properties of the transition metal dichalcogenide is difficult, and thus, only a technology in a level of chemically coating the transition metal dichalcogenide (CN 110554455) has been developed.

### RELATED ART DOCUMENTS

### Patent Documents

Chinese Patent Publication No. 110554455

### SUMMARY

An embodiment of the present invention is directed to providing a method of fiberizing a transition metal dichalcogenide and a transition metal dichalcogenide fiber.

In one general aspect, a method of producing a transition metal dichalcogenide fiber includes: spinning a spinning solution containing a transition metal dichalcogenide in a coagulation solution to obtain a transition metal dichalcogenide fiber, wherein the spinning solution has liquid crystallinity by the transition metal dichalcogenide.

In the production method according to an exemplary embodiment of the present invention, one or more factors of the following Factors I) to III) are adjusted to impart liquid crystallinity to the spinning solution:

Factor I) number of transition metal dichalcogenide layers,

Factor II) average diameter of the transition metal dichalcogenide, and

Factor III) content of the transition metal dichalcogenide.

In the production method according to an exemplary embodiment of the present invention, the transition metal dichalcogenide may be mono-layered.

In the production method according to an exemplary embodiment of the present invention, the transition metal dichalcogenide may have a wave number difference between a peak by an in-plane vibration mode of each of a transition metal layer and a chalcogen layer and a peak by a vibration mode in a direction perpendicular to the chalcogen layer in a Raman spectrum of 18 cm⁻¹ or more.

In the production method according to an exemplary embodiment of the present invention, the transition metal dichalcogenide may have an average diameter of an order of 10⁰ μm to an order of 10¹ μm.

In the production method according to an exemplary embodiment of the present invention, the spinning solution may contain 0.5 wt % or more of the transition metal dichalcogenide.

In the production method according to an exemplary embodiment of the present invention, the spinning solution may further contain a polymer additive which is a cellulose-based polymer, a polyoxyalkylene-based polymer, a polyacryl-based polymer, a polyvinyl-based polymer, a polysaccharide, or a mixture thereof.

In the production method according to an exemplary embodiment of the present invention, the spinning solution may contain 5 to 20 wt % of the polymer additive.

In the production method according to an exemplary embodiment of the present invention, a cross-sectional shape of a nozzle from which the spinning solution is spun may be controlled to adjust a cross-sectional shape of the transition metal dichalcogenide fiber.

In the production method according to an exemplary embodiment of the present invention, the cross-sectional shape of the nozzle may be a circular shape, an oval shape, or a polygonal shape with rounded edges.

In the production method according to an exemplary embodiment of the present invention, the coagulation solution may contain a polar solvent and a non-polar solvent having miscibility with the polar solvent.

In the production method according to an exemplary embodiment of the present invention, during the spinning, a shear stress may be applied to the transition metal dichalcogenide fiber in the coagulation solution by rotation of the coagulation solution.

In the production method according to an exemplary embodiment of the present invention, a step of heat-treating a fiber obtained by the spinning may be further included.

In another general aspect, a transition metal dichalcogenide fiber produced by the method described above is provided.

The transition metal dichalcogenide fiber according to the present invention may have a structure in which a transition metal dichalcogenide is laminated layer by layer, cross-sectionally.

In the fiber according to an exemplary embodiment of the present invention, the fiber may have an apparent density of 0.5×10⁻⁶ to 5×10⁻⁶ g/cm³.

The fiber according to an exemplary embodiment of the present invention may have liquid crystallinity.

In the fiber according to an exemplary embodiment of the present invention, the fiber may have a diameter of 10 to 500 μm.

In the fiber according to an exemplary embodiment of the present invention, the fiber may have an organic content of 10 wt % or less.

In the fiber according to an exemplary embodiment of the present invention, a transition metal of the transition metal dichalcogenide may be one or more selected from the group consisting of Sn, Mo, W, Hf, W, Re, Ni, Zr, V, Ti, Nb, Ta, Tc, Co, Rh, Ir, Pd, and Pt, and a chalcogen element may be one or more selected from the group consisting of S, Se, and Te.

In still another general aspect, an optical device or an electronic device including the transition metal dichalcogenide fiber described above is provided.

Other features and aspects will be apparent from the following detailed description, the drawings, and the claims.

### BRIEF DESCRIPTION OF THE DRAWINGS

FIGS. 1A and 1B are photographs of a transition metal dichalcogenide contained in a spinning solution, observed by a scanning electron microscope.

FIG. 2 is a drawing illustrating a Raman spectrum of the transition metal dichalcogenide.

FIGS. 3A and 3B are optical photographs observing liquid crystallinity of the spinning solution.

FIGS. 4A to 4C are optical and scanning electron microscope photographs observing a wet spinning process and a transition metal dichalcogenide fiber.

FIG. 5 is a photograph observing the transition metal dichalcogenide fiber with a polarized optical microscope.

FIGS. 6A to 6C are drawings illustrating a Raman spectrum and a photoluminescence characteristic of the transition metal dichalcogenide fiber produced.

### DETAILED DESCRIPTION OF EMBODIMENTS

Hereinafter, the transition metal dichalcogenide fiber and the method of producing the same of the present invention will be described in detail with reference to the accompanying drawings. The drawings to be provided below are provided by way of example so that the idea of the present invention can be sufficiently transferred to a person skilled in the art to which the present invention pertains. Therefore, the present invention is not limited to the drawings provided below but may be embodied in many different forms, and the drawings suggested below may be exaggerated in order to clear the spirit of the present invention. Technical terms and scientific terms used herein have the general meaning understood by those skilled in the art to which the present invention pertains unless otherwise defined, and a description for the known function and configuration which may unnecessarily obscure the gist of the present invention will be omitted in the following description and the accompanying drawings.

In addition, the singular form used in the specification and claims appended thereto may be intended to also include a plural form, unless otherwise indicated in the context.

In the present specification and the appended claims, the terms such as “first” and “second” are not used in a limited meaning but are used for the purpose of distinguishing one constitutional element from other constitutional elements.

In the present specification and the appended claims, the terms such as “comprise” or “have” means that there is a characteristic or a constitutional element described in the specification, and as long as it is not particularly limited, a possibility of adding one or more other characteristics or constitutional elements is not excluded in advance.

In the present specification and the appended claims, when a portion such as a film (layer), a region, and a constitutional element are present on another portion, not only a case in which the portion is in contact with and directly on another portion but also a case in which other films (layers), other regions, other constitutional elements are interposed between the portions is included.

In the present invention, unless otherwise particularly defined, the transition metal dichalcogenide may refer to a mono-layered transition metal dichalcogenide or few-layered transition metal dichalcogenide of several Van der Waals-bonded mono-layers.

A transition metal dichalcogenide in a bulk state is referred to as a transition metal chalcogen compound, so as to be clearly distinguished from the mono-layered or few-layered transition metal dichalcogenide.

The transition metal dichalcogenide is a compound having a two-dimensional layered structure composed of a transition metal and a chalcogen element, and may satisfy MX₂ (M=transition metal, X=chalcogen). The transition metal dichalcogenide has a structure in which a transition metal single element layer is positioned between two chalcogen element layers, and three atomic layers may gather to form one two-dimensional material layer (single molecular layer).

The three atomic layers (X-M-X) forming the two-dimensional material layer are covalently bonded to each other, but an interlayer of the two-dimensional material layer is very weakly interacted by Van der Waals force. Since it is difficult to produce the transition metal dichalcogenide itself in a thin fiber form by the weak interaction of the two-dimensional material layers, a method of coating or surface-synthesizing the transition metal dichalcogenide on a different type of fibrous core was used.

The present applicant conducted a study for fiberizing the transition metal dichalcogenide itself for a long time so that the physical properties of the transition metal dichalcogenide itself may be implemented as they are on a fiber, and as a result, found that when the transition metal dichalcogenide dispersion satisfies specific conditions, it has liquid crystallinity, and when the transition metal dichalcogenide dispersion has liquid crystallinity, it is possible to fiberize the transition metal dichalcogenide only by simply spinning the dispersion.

The method of producing a transition metal dichalcogenide fiber according to the present invention, based on the discovery, includes: spinning a spinning solution containing a transition metal dichalcogenide in a coagulation solution to obtain a transition metal dichalcogenide fiber, wherein the spinning solution may have liquid crystallinity by the transition metal dichalcogenide.

When the spinning solution containing the transition metal dichalcogenide has liquid crystallinity, the transition metal dichalcogenide fiber may be produced by a simple spinning process usually used in a conventional fiber production. Furthermore, when the spinning solution containing the transition metal dichalcogenide has liquid crystallinity, the transition metal dichalcogenide fiber may be produced by simple spinning without assistance of a separate additive for strengthening binding force between the transition metal dichalcogenides contained in the spinning solution. This means that it is possible to produce a pure transition metal dichalcogenide fiber composed of a transition metal dichalcogenide. However, production of the pure transition metal dichalcogenide fiber is only possible by technical excellence of the present invention and it should not be limitedly construed that the spinning solution is composed of a transition metal dichalcogenide and a dispersion medium, and if necessary, the spinning solution may further contain an additive material which is commonly used in fibrosis of an inorganic material for satisfying physical properties advantageous for a specific spinning method and conditions, such as viscosity, of course.

The spinning solution may have liquid crystallinity by the transition metal dichalcogenide. This means that a solution containing the same materials at the same contents as the spinning solution except the transition metal dichalcogenide does not show liquid crystallinity.

As is known, a liquid crystal is a material state showing both fluidity of a liquid and anisotropy of a solid crystal, and a liquid crystal phase shows fluidity like a liquid while a material state has an orientational order.

The liquid crystallinity of the spinning solution containing a transition metal dichalcogenide may be confirmed by observation of the spinning solution with a polarization microscope, a milky way observed when the spinning solution is poured into a transparent container and shaken, and the like.

The spinning solution may have liquid crystallinity by one or more factors of the following Factors I) to III). That is, the production method according to an exemplary embodiment of the present invention may include: adjusting one or more factors of the following Factors I) to III) to prepare a spinning solution containing a transition metal dichalcogenide and having liquid crystallinity; and spinning the spinning solution in a coagulation solution to obtain a transition metal dichalcogenide fiber:

Factor I) number of transition metal dichalcogenide layers,

Factor II) average diameter of the transition metal dichalcogenide, and

Factor III) content of the transition metal dichalcogenide.

Regarding Factor I), in terms of preparation of the spinning solution having liquid crystallinity, the transition metal dichalcogenide may be mono-layered. As a substantial example, 90% or more, more substantially 95% or more, still more substantially 98% or more, and even more substantially 99% or more of the transition metal dichalcogenide contained in the spinning solution may be a single molecular layer transition metal dichalcogenide. Here, the mono-layer (single molecular layer) may be collectively referred to as a two-dimensional material layer or a tri-atomic layer of X (chalcogen)-M (transition metal)-X (chalcogen).

With or independently of this, regarding Factor I), in terms of preparation of the spinning solution having liquid crystallinity, the transition metal dichalcogenide may satisfy a wave number difference between a peak by an in-plane vibration mode (E¹_{2g} mode) of each of a transition metal layer and a chalcogen layer and a peak by a vibration mode (A_{1g} mode) in a direction perpendicular to the chalcogen layer in a Raman spectrum of the transition metal dichalcogenide of 18 cm⁻¹ or more. Specifically, the E¹_{2g} mode in a Raman spectrum of the transition metal dichalcogenide is a mode in which the transition metal of the transition metal layer and the chalcogen of the chalcogen layer vibrate in an opposite direction in-plane of each layer, and the A_{1g} mode is a mode in which the chalcogen atoms of the upper and lower chalcogen layers vibrate against each other in a direction perpendicular to the layers (out-of-plane) while the transition metal does not move. The wave number difference (wave number difference between a E¹_{2g} peak center and an A_{1g} peak center) of a Raman peak by the mode varies with the number of molecular layers forming the transition metal dichalcogenide. The wave number difference between the E¹_{2g} peak center and the A_{1g} peak center in the Raman spectrum being 18 cm⁻¹ or more means that the transition metal dichalcogenide is mono-layered.

With or independently of this, regarding Factor II), the transition metal dichalcogenide may be very coarse with an average diameter of an order of 10⁰ μm to an order of 10¹ μm. Though the coarse transition metal dichalcogenide is very advantageous for imparting liquid crystallinity to the spinning solution, considering a tip size of a nozzle used in spinning, when the transition metal dichalcogenide is excessively coarse, there is a risk of causing physical wrinkles in the transition metal dichalcogenide. Thus, the transition metal dichalcogenide may have an average diameter of about 1 μm to 50 μm, preferably about 5 μm to 20 μm, and more preferably about 5 μm to 15 μm.

Experimentally, the average diameter of the transition metal dichalcogenide may be an average diameter obtained by measuring each area of the transition metal dichalcogenide in a photograph image of the transition metal dichalcogenide observed by a scanning electron microscope or the like, converting the measurements into circles having the same area, and calculating an average area calculated based on diameters of the circles. Here, the number of transition metal dichalcogenide of which the size is measured may be 50 or more, specifically 100 or more, and substantially 500 or more, but is not necessarily limited thereto.

With or independently of this, regarding Factor III), the spinning solution may contain 0.5 wt % or more of the transition metal dichalcogenide. The high concentration of the transition metal dichalcogenide as such is also very advantageous for imparting liquid crystallinity to the spinning solution. Substantially, the spinning solution may contain 0.5 to 2 wt %, and more specifically 0.5 to 1 wt % of the transition metal dichalcogenide.

In a specific example, the spinning solution having liquid crystallinity to allow production of a transition metal dichalcogenide fiber by simple spinning may be produced, by making one or more of Factors I) to III), substantially two or more of Factor I) based on Raman spectrum characteristics, Factor II), and Factor III), and more substantially all of Factor I) based on Raman spectrum characteristics, Factor II), and Factor III) satisfy the conditions described above.

That is, the production method according to an exemplary embodiment of the present invention may include adjusting Factor I) so as to satisfy the Raman spectrum described above, adjusting Factor II) to about 1 μm to 50 μm, preferably about 5 μm to 20 μm, and more preferably about 5 to 15 μm, and adjusting Factor III) to 0.5 wt % or more to prepare a spinning solution containing a transition metal dichalcogenide and having liquid crystallinity; and spinning the spinning solution in a coagulation solution to obtain a transition metal dichalcogenide fiber.

In a specific example, a dispersion medium may be a polar solvent. The polar solvent may be an alcohol-based solvent, a ketone-based solvent, an ester-based solvent, an amine-based solvent, an ether-based solvent, water, or a mixed solvent thereof. As an example, the alcohol-based solvent may be methanol, ethanol, methoxyethanol, propanol, isopropanol, butanol, isobutanol, and the like, the ketone-based solvent may be acetone, methyl ethyl ketone, methyl isobutyl ketone, and the like, the ester-based solvent may be ethyl acetate, butyl acetate, 3-methoxy-3-methyl butyl acetate, and the like, the amine-based solvent may be dimethylformamide, methyl pyrrolidone, dimethylacetamide, and the like, and the ether solvent may be tetrahydrofuran, 2-methyltetrahydrofuran, dimethylether, dibutylether, and the like, but the present invention is not limited thereto. However, in terms of guaranteeing stable dispersion of the transition metal dichalcogenide, the dispersion medium of the spinning solution may be a polar organic solvent having a Hansen solubility index (δt) of 20 MPa^{0.5} or more, and among hansen solubility parameters, δₚ of 10 MPa^{0.5} or more and δₕ of 5 MPa^{0.5} or more.

In a specific example, the spinning of the spinning solution may be wet spinning. As is well known in a textile field, wet spinning is a method of extruding a spinning solution through a spinneret (orifice or nozzle) in a coagulation solution and solidifying the extruded spinning solution into a fibrous form in the coagulation solution. Here, the fiber obtained in the coagulation solution may be wound inside or outside the coagulation solution, of course.

In a specific example, a temperature at which the spinning solution is spun may be 10 to 50° C., specifically 20 to 30° C., and substantially at room temperature, but is not limited thereto. In addition, a discharge speed of the spinning solution during the spinning of the spinning solution may be 0.1 ml/min to 0.2 ml/min, but is not limited thereto. A winding speed may correspond to the discharge speed, but is not limited thereto.

In a specific example, rotation of the coagulation solution may be performed during the spinning of the spinning solution. That is, solidification of fiber and application of shear stress to fiber may be performed simultaneously by rotating the coagulation solution during the spinning. A rotation speed of the coagulation solution (coagulation bath containing coagulation solution) may be 1 to 100 rpm, preferably 20 to 50 ppm, but is not limited thereto. Shear stress is applied to fiber (including solidifying fiber) by the rotation of the coagulation solution, and the transition metal dichalcogenide may be oriented in an axis direction of the fiber by the shear stress. Orientation in the axis direction of the transition metal dichalcogenide fiber is advantageous since percolation may be performed only with a smaller amount of transition metal dichalcogenide. In addition, the application of shear stress in the coagulation solution may increase orientation of the transition metal dichalcogenide in fiber to improve mechanical/electrical physical properties of the fiber, which is thus advantageous.

Furthermore, coarseness of the transition metal dichalcogenide, related to Factor II) to impart liquid crystallinity to the spinning solution, allows the transition metal dichalcogenide to be more easily oriented in the axis direction of fiber by shear stress applied to the fiber by coagulation solution rotation, which is advantageous in terms of orientation improvement.

In a specific example, a cross-sectional shape of a nozzle from which the spinning solution is spun may be controlled to adjust the cross-sectional shape of the transition metal dichalcogenide fiber. Specifically, the transition metal dichalcogenide fiber having various shapes of cross sections may be produced depending on the shapes of the nozzle from which the spinning solution is spun. As an example, the cross-sectional shape of the nozzle (shape of a nozzle tip) may be a circular shape, an oval shape, or a polygonal (rectangular, square, or triangular) shape having rounded edges, and in this case, the cross-section of the transition metal dichalcogenide fiber produced may have a circular shape, an oval shape, or a polygonal shape having smoothly curved edges. Here, the fiber shape to be desired may be appropriately changed considering the specific application thereof, of course.

A diameter of the nozzle (diameter of nozzle tip opening) may be, for example, about 50 to 1,000 μm, specifically about 100 to 1,000 μm, and more specifically about 150 to 800 μm, but is not limited thereto.

Though shrinkage may occur to some extent due to the solidification in the coagulation solution, the diameter of the transition metal dichalcogenide fiber produced by spinning may be controlled by the diameter of the nozzle, and the transition metal dichalcogenide fiber having a wide range of diameters from fine fibers to coarse fibers may be produced by the spinning. As an example, the transition metal dichalcogenide fiber may have a diameter of 10 to 500 μm, specifically 10 to 300 μm, and more specifically 10 to 250 μm, but is not limited thereto.

In a specific example, the coagulation solution may contain a polar solvent and a non-polar solvent having miscibility with the polar solvent. Thus, the coagulation solution may contain a mixed solvent of a polar solvent and a non-polar solvent having miscibility with the polar solvent. The mixed solvent is advantageous, since it allows solidification of a spinning solution to be spun and has an appropriately controlled solidification speed to produce a fiber having homogeneous characteristics from a center to a surface of fiber, and the solidification may be completed after orientation of the transition metal dichalcogenide is adjusted by shear stress applied during solidification.

A content of the non-polar solvent relative to the polar solvent in the coagulation solution may affect a solidification speed of the spinning solution spun from a nozzle. A fiber having homogeneous physical properties on a fiber cross-section may be produced, the transition metal dichalcogenide may be oriented in the axis direction of fiber in the entire area of the fiber by shear stress applied during solidification, and a volume ratio of the polar solvent:non-polar solvent contained in the coagulation solution may be about 1:0.05 to 0.20, specifically about 1:0.05 to 0.15.

The non-polar solvent (without polarity) of the coagulation solution only has miscibility with a polar solvent specific material of the coagulation solution, considering the corresponding material. As is known, the non-polar solvent may be a solvent having no partial charge or a solvent in which polar bonds are arranged in a manner of offsetting the effect of a partial charge. As an example, the non-polar solvent may be pentane, hexane, heptane, cyclopentane, cyclohexane, benzene, toluene, 1,4-dioxane, dichloromethane, methyl tert-butyl ether, chloroform, carbon tetrachloride, diethyl ether, and the like, but is not limited thereto. Here, the polar solvent of the coagulation solution may be, independently of the polar solvent of the spinning solution, only an alcohol-based solvent, a ketone-based solvent, an ester-based solvent, an amine-based solvent, an ether-based solvent, water, or a mixed solvent thereof.

During the spinning, a temperature of the coagulation solution may be 10 to 50° C., specifically 20 to 30° C., and substantially at room temperature, but is not limited thereto.

The spinning solution may further contain a polymer additive which is dissolved in a polar solvent, if necessary, considering the diameter of the nozzle or a spinning pressure during the spinning. The polymer additive may serve to adjust a viscosity of the spinning solution depending on spinning conditions. However, most of the polymer additive may be substantially removed by a heat treatment at a low temperature of the transition metal dichalcogenide fiber obtained by wet spinning. This means that a relatively pure transition metal dichalcogenide fiber may be produced even in the case of adjusting the viscosity with the polymer additive to use a stable and commercially advantageous spinning process.

The polymer additive may be a cellulose-based polymer, a polyoxyalkylene-based polymer, a polyacryl-based polymer, a polyvinyl-based polymer, a polysaccharide, a mixture thereof, or the like. The cellulose-based polymer may be a cellulose ether (cellulose ether-based), and a specific example of the cellulose ether may include hydroxyethyl methylcellulose, hydroxypropyl methylcellulose, ethyl hydroxyethyl cellulose, a mixture thereof, or the like. A specific example of the polyoxyalkylene-based polymer may include polyethyleneglycol, polypropyleneglycol, a polyethyleneglycol-propyleneglycol copolymer, a mixture thereof, or the like, a specific example of the polyacryl-based polymer may include sodium polyacrylate, polyethylacrylate, polyacrylamide, a mixture thereof, or the like, the polyvinyl-based polymer may be polyvinylalcohol, polyvinylacetate, polyvinylpyrrolidone, a mixture thereof, or the like, and the polysaccharide may be glycogen, amylose, amylopectin, callose, agar, algin, alginate, pectin, carrageenan, chitin, chitosan, curdlan, dextran, collagen, starch, xanthan, a mixture thereof, or the like, but the present invention is not limited thereto.

As described above, the spinning solution only has a content to have a more advantageous viscosity for spinning, considering specific spinning conditions (nozzle tip size, spinning pressure, and the like). As an example, the spinning solution may contain 5 to 20 wt % of the polymer additive, but the present invention is not limited thereto.

After performing the spinning, a step of washing and drying the produced transition metal dichalcogenide fiber may be further performed. Washing may be performed using the same or similar solution as/to the coagulation solution used in the wet spinning, but is not limited thereto. Drying may be simple drying or stretch drying. By performing stretching during drying, elasticity of the produced transition metal dichalcogenide fiber may be improved. When stretch drying is performed, a stretch ratio (fiber cross-sectional area before stretching/fiber cross-sectional area after stretching×100 (%)) may be more than 1 and 2 or less, and a drying temperature may be 20 to 80° C., specifically 20 to 50° C., and more specifically room temperature, but is not necessarily limited thereto.

After performing drying or washing, a step of heat-treating the transition metal dichalcogenide fiber may be further performed. The transition metal dichalcogenide in fiber may be oriented in a layer-by-layer laminated structure in the axis direction of fiber by a shear stress applied during a wet spinning process, and due to the improved orientation, the fiber may have a structure in which the transition metal dichalcogenide in the fiber is connected in series (percolated) in the axis direction of the fiber. The fiber form may be stably maintained, even in the case of removing the polymer additive by a heat treatment, by the percolation of the transition metal dichalcogenide. In addition, since a critical value of the percolation is low by improved orientation, the content (concentration) of the transition metal dichalcogenide is adjusted to show liquid crystallinity in the spinning solution, but the possible content of the transition metal dichalcogenide in the spinning solution may be lowered to about 0.5 to 2 wt %, substantially about 0.5 to 1.5 wt %, and more substantially about 0.5 to 1 wt %. The percolation implemented at such a low concentration may prevent coagulation of the transition metal dichalcogenide in fiber, when removing the polymer additive during fibrosis and by a heat treatment. As described above, even when the polymer additive is removed by a heat treatment, a fiber form may be maintained by the percolation of the transition metal dichalcogenide, and since the percolation is possible even at a concentration (concentration of the transition metal dichalcogenide in the spinning solution) of 0.5 wt %, coagulation of the transition metal dichalcogenide by a heat treatment may be prevented.

A heat treatment temperature may be only in a range of removing the polymer additive and not thermally damaging the transition metal dichalcogenide. As a specific example, the heat treatment may be performed at a temperature of 150 to 250° C., more specifically 150 to 200° C., but is not necessarily limited thereto. Based on a total mass of the organic material (including the polymer additive) included in the transition metal dichalcogenide fiber before the heat treatment, 30% or more, specifically 50% or more, more specifically 70% or more, still more specifically 80% or more, and even more specifically 90% or more of the organic material may be removed by the heat treatment, and the organic material may be removed to 100%. The heat treatment may be performed in an inert gas atmosphere or in a vacuum, for 10 minutes to 1 hour, but is not necessarily limited thereto.

In a specific example, a transition metal of the transition metal dichalcogenide may be one or more selected from the group consisting of Sn, Mo, W, Hf, W, Re, Ni, Zr, V, Ti, Nb, Ta, Tc, Co, Rh, Ir, Pd, and Pt, and a chalcogen element may be one or more selected from the group consisting of S, Se, and Te. That is, the transition metal dichalcogenide may satisfy a chemical formula of MX₂, wherein M may be one or more selected from the group consisting of Sn, Mo, W, Hf, W, Re, Ni, Zr, V, Ti, Nb, Ta, Tc, Co, Rh, Ir, Pd, and Pt and X may be one or more selected from the group consisting of S, Se, and Te, but the present invention is not necessarily limited thereto. A specific material of the transition metal dichalcogenide may be only a material having physical properties appropriate for the corresponding application, considering the specific use of the fiber. As a non-limiting example, when the use of a photoabsorber of a solar cell, a channel material of a semiconductor device such as a transistor, an optical device such as a light-emitting transistor or a light-emitting diode, and the like is considered, the transition metal dichalcogenide may be MoS₂, WS₂, MoSe₂, WSe₂, and the like, considering a high charge mobility, appropriate band gap energy, and the like.

The present invention includes a transition metal dichalcogenide fiber produced by the production method described above.

Independently of this, the present invention includes a transition metal dichalcogenide fiber in which the transition metal dichalcogenide is laminated layer by layer, cross-sectionally.

The layer-by-layer lamination refers to a structure in which the layers of the transition metal dichalcogenide are laminated to face each other. However, the layer-by-layer lamination should not be interpreted as only a structure in which the layers of the transition metal dichalcogenide are physically in contact with each other to be laminated, and should be interpreted as including a structure in which the layers face to each other in a separated state from each other as well as a structure in which the layers are laminated in physical contact with each other. In addition, the laminated layer in the layer-by-layer lamination should not be necessarily interpreted as a mono-layer of the transition metal dichalcogenide limitedly, and should be interpreted as also including transition metal dichalcogenide flakes produced by laminating several mono-layers in spinning and solidification process in a coagulation solution. Here, the transition metal dichalcogenide flake may be a lamination of 2 to 5, 2 to 4, or 2 or 3 transition metal dichalcogenide mono-layers, but is not limited thereto. As described above, the layer in the layer-by-layer lamination may refer to a layer of the transition metal dichalcogenide mono-layer and/or a layer of the transition metal dichalcogenide flake. In addition, in the layer-by-layer lamination, each layer may be oriented along an axis direction of fiber.

In a specific example, the transition metal dichalcogenide fiber may have liquid crystallinity. The liquid crystallinity of fiber may be confirmed from a color observed in the fiber in polarization microscope observation.

In a specific example, an apparent density of the transition metal dichalcogenide fiber may be 0.5×10⁻⁶ to 5×10⁻⁶ g/cm³, specifically 1.0×10⁻⁶ to 2.0×10⁻⁶ g/cm³, and more specifically 1.0×10⁻⁶ to 1.5×10⁻⁶ g/cm³.

A diameter of the transition metal dichalcogenide fiber is not particularly limited, but may be about 10 to 500 μm, specifically about 10 to 300 μm, and more specifically about 10 to 250 μm.

In a specific example, the transition metal dichalcogenide fiber may contain substantially no organic material or 10 wt % or less of an organic material, and more specifically, the transition metal dichalcogenide fiber may contain 8 wt % or less, 5 wt % or less, 3 wt % or less, and substantially 1 wt % or less of an organic material. Here, the organic material may include the polymer additive described above which is used during spinning.

The present invention may include a flexible device and a wearable device which include the transition metal dichalcogenide fiber described above. Here, the flexible or wearable device may be a semiconductor device, a display device, a detection device, an energy storage device, an optical device, a power generation device, or the like.

In the following Example, a transition metal chalcogen compound bulk crystal was used for using a coarse transition metal dichalcogenide to produce a transition metal dichalcogenide. However, a commercially available transition metal dichalcogenide may be used as long as the liquid crystallinity impartation factor described above (specifically Factor I) and Factor II)) is satisfied. Thus, though the transition metal dichalcogenide is directly produced and used in the Example, the present invention should not be limited to the specific exfoliation method or production method of the transition metal dichalcogenide.

### EXAMPLE

A transition metal chalcogen compound bulk crystal (MoS₂, 0.01 g) was introduced to a mixed solution of acetonitrile (40 ml) and tetraheptyl ammonium bromide (THAB, 0.2 g), and intercalated at 10 V. Thereafter, the intercalated MoS₂ bulk crystal was recovered, introduced to a mixed solution of dimethylformamide (DMF, 10 ml) and polyvinylpyrrolidone (PVP, Mw=40,000, 0.22 g), and exfoliated by ultrasonic application for 5 minutes to prepare a stripping solution. Thereafter, the stripping solution was centrifugated (15,000 rpm, 60 minutes) to remove unexfoliated pieces, and polyvinylpyrrolidone was further introduced for viscosity adjustment to prepare a spinning solution. A concentration of the transition metal dichalcogenide was 5 mg/ml and a concentration of polyvinylpyrrolidone was 10 wt % in the prepared spinning solution.

The prepared spinning solution was spun by a wet spinning process. Spinning conditions are as follows: Spinning conditions: spinning solution temperature: 25° C., spinning solution discharge speed: 0.2 ml/min, circular nozzle diameter (internal diameter): 12 μm, coagulation solution which is a mixed solution of acetone, hexane, and ethyl acetate (mixed volume ratio ethyl acetate 5: acetone 5: hexane 1), coagulation solution temperature: 25° C., coagulation solution bath rotation speed: 30 rpm.

A transition metal dichalcogenide fiber was produced by the wet spinning under the conditions described above. Thereafter, washing was performed with the same coagulation solution, and the washed transition metal dichalcogenide fiber was stretch dried so as to be stretched at a stretching ratio (ratio of cross-sectional area of fiber before stretching/cross-sectional area of fiber after stretching) of about 1.3 to 1.4 at a temperature of 25° C. to produce a stretched transition metal dichalcogenide fiber. After performing stretching, the fiber was heat-treated at 150° C. or 200° C. for 30 minutes to produce a heat-treated transition metal dichalcogenide fiber. Hereinafter, the transition metal dichalcogenide fiber obtained by wet spinning is referred to as “transition metal dichalcogenide fiber”, the transition metal dichalcogenide fiber obtained by stretch drying is referred to as “stretched transition metal dichalcogenide fiber”, and the heat-treated transition metal dichalcogenide fiber after stretching is referred to as “heat-treated transition metal dichalcogenide fiber”.

The produced transition metal dichalcogenide fiber had a diameter of 12 μm and unintentional fiber break or a significant change of the diameter in the wet spinning process was not observed. It was confirmed by thermo gravimetric analysis that the produced transition metal dichalcogenide fiber contained 10 wt % of polyvinylpyrrolidone, and the apparent density of the transition metal dichalcogenide fiber was 1.23×10⁻⁶ g/cm³.

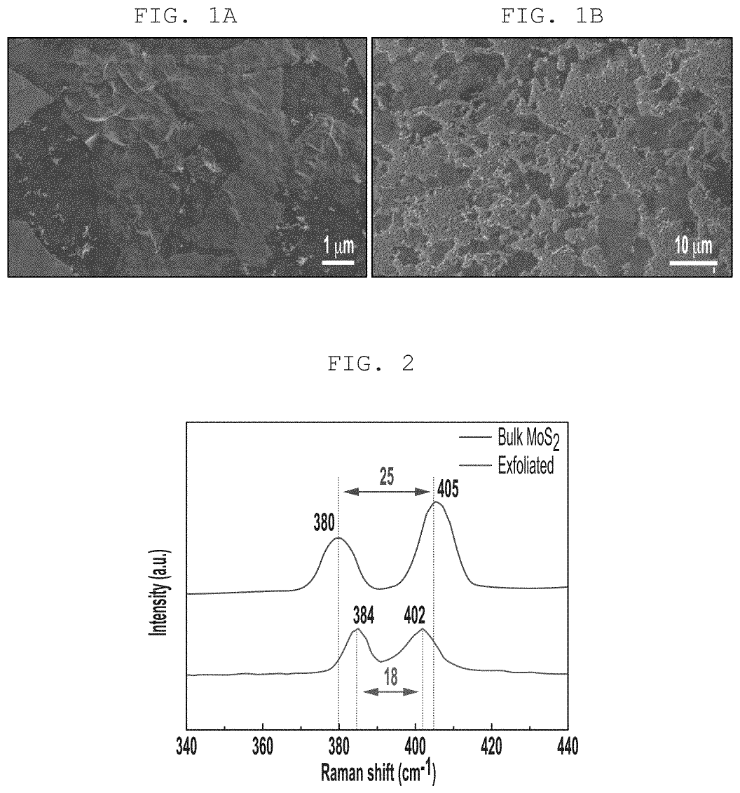

FIGS. 1A and 1B are photographs of a recovered transition metal dichalcogenide observed by a scanning electron microscope, after recovering the prepared spinning solution by filtration with an anodic aluminum oxide (AAO) membrane filter. As seen in FIGS. 1A and 1B, the transition metal dichalcogenide contained in the spinning solution is coarse so that its average diameter is about 6 μm.

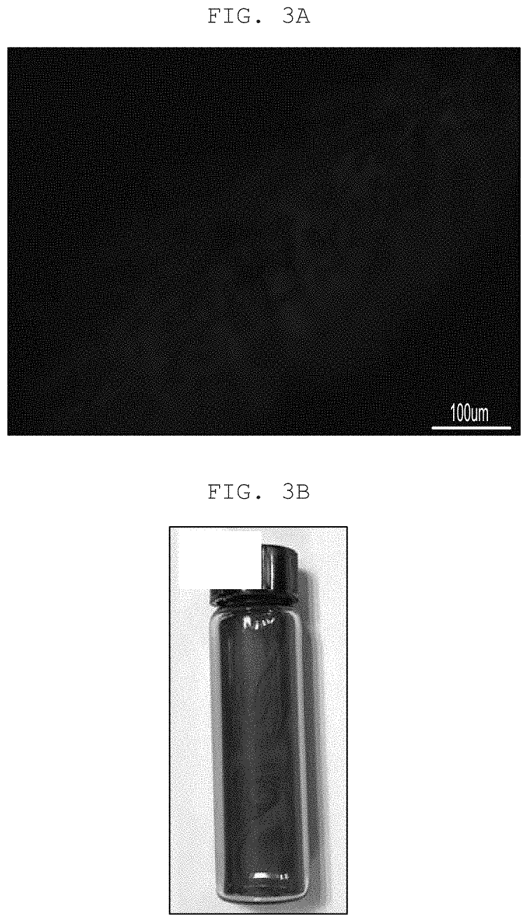

FIG. 2 is a drawing illustrating a Raman spectrum (irradiation wavelength: 532 nm) of the produced transition metal dichalcogenide (transition metal dichalcogenide contained in the spinning solution), and as seen in FIG. 2, a wave number difference between peak centers of a peak by an E¹_{2g} mode and a peak by an A_{1g} mode was 18 cm⁻¹. The wave number difference is results showing that substantially all transition metal dichalcogenide contained in the spinning solution was mono-layered.

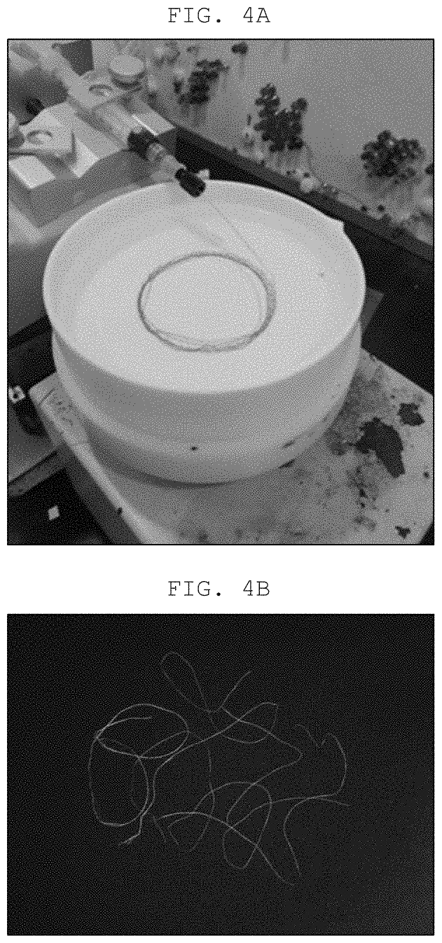

FIGS. 3A and 3B are photographs in which the liquid crystallinity of the prepared spinning solution was observed; FIG. 3A is a drawing illustrating the results observed by a polarized optical microscope (POM) and FIG. 3B is a drawing observing a milky way shown when shaking the spinning solution. As seen from FIGS. 3A and 3B, the produced spinning solution showed liquid crystallinity.

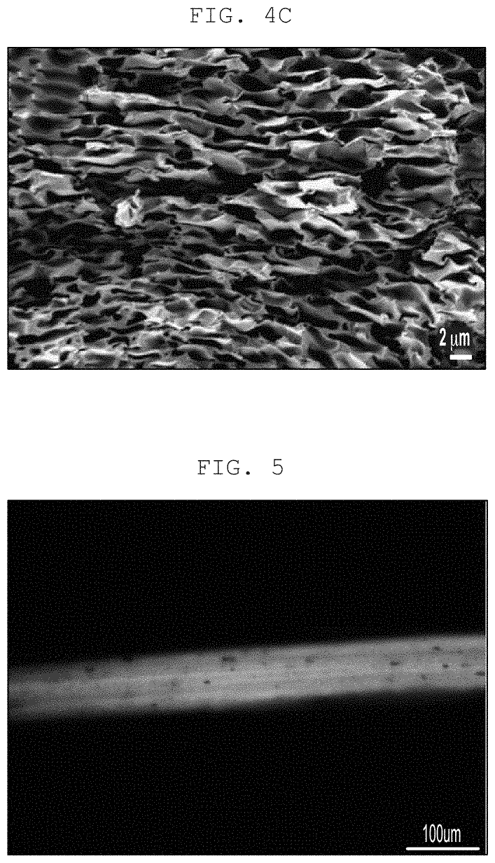

FIGS. 4A to 4C are photographs in which the wet spinning process and the transition metal dichalcogenide fiber were observed; FIG. 4A is an optical photograph of the wet spinning process, FIG. 4B is an optical photograph in which the transition metal dichalcogenide fiber (transition metal dichalcogenide fiber obtained by the wet spinning) was observed, and FIG. 4C is a scanning electron micrograph in which the cross-section of the transition metal dichalcogenide fiber was observed.

As seen in FIGS. 4A to 4C, it is seen that the transition metal dichalcogenide was produced in a fiber form having a uniform thickness by the wet spinning, and it was confirmed that the transition metal dichalcogenide having a diameter of about 6 μm contained in the spinning solution formed a layer-by-layer lamination structure without severe wrinkling or physical deformation. In addition, it was confirmed that both the center and the surface of the fiber had substantially the same microstructure as FIG. 4C.

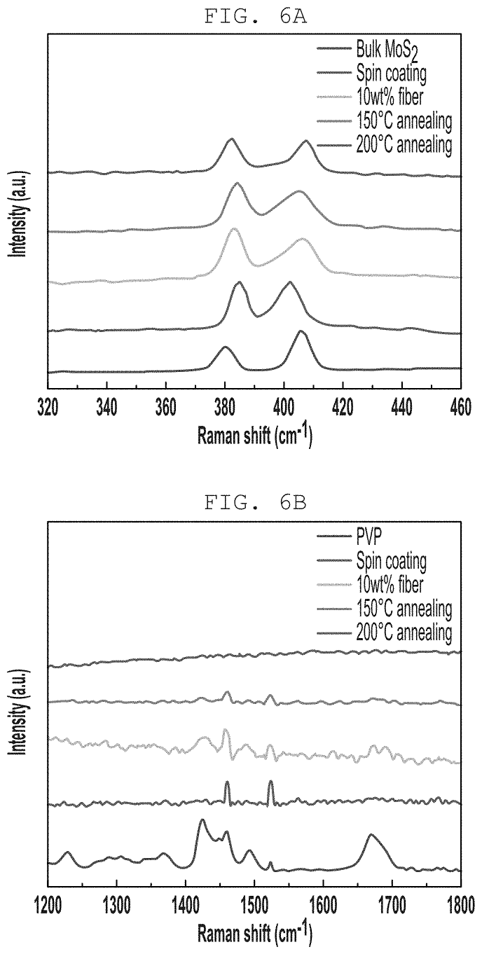

FIG. 5 is a photograph in which the produced transition metal dichalcogenide fiber was observed with a polarized optical microscope, and as seen in FIG. 5, it was confirmed that the inside of the fiber was yellowish, and it is seen therefrom that the spun fiber also had liquid crystallinity.

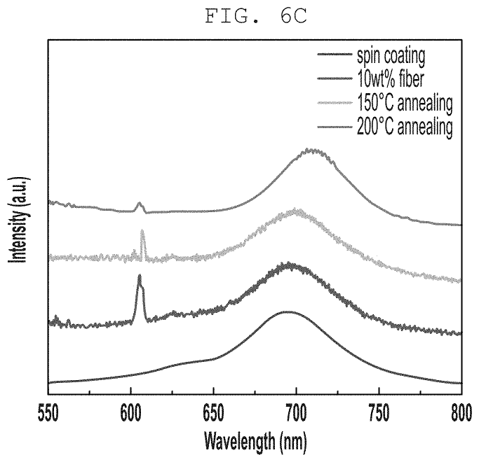

FIGS. 6A to 6C are drawings illustrating the measured Raman spectra (FIGS. 6A and 6B) and the photoluminescence (PL) characteristics (FIG. 6C) of the heat-treated transition metal dichalcogenide fiber and the transition metal dichalcogenide fiber produced by wet spinning. Specifically, in FIGS. 6A to 6C, “10 wt % fiber” refers to the transition metal dichalcogenide fiber produced by wet spinning, “150° C. annealing” refers to the transition metal dichalcogenide fiber which was heat-treated at 150° C., and “200° C. annealing” refers to the transition metal dichalcogenide fiber which was heat-treated at 200° C. In addition, for comparison, the results of the transition metal dichalcogenide film produced by spin coating of the spinning solution without wet spinning are illustrated together as “spin coating”, the results of the transition metal chalcogen compound bulk crystal (MoS₂) are illustrated as “Bulk MoS₂” in the transition metal dichalcogenide Raman spectrum of FIG. 6A, and the results of pure polyvinylpyrrolidone are illustrated with “PVP” in the organic material-related Raman spectrum of FIG. 6B.

From FIG. 6A, it is seen that the natural physical properties of the transition metal dichalcogenide were maintained as they are after the wet spinning, of course, and even after the heat treatment at 150° C. or 200° C. In addition, it is seen from FIG. 6B that the organic additive (polyvinylpyrrolidone) remaining in the fiber in the wet spinning was removed by the heat treatment, and when heat-treated at 200° C., the organic additive was substantially not detected.

FIG. 6C is a drawing illustrating photoluminescence characteristics measured by irradiating each of the transition metal dichalcogenide fiber produced by wet spinning and the heat-treated transition metal dichalcogenide fiber with a laser having a wavelength of 514 nm. From FIG. 6C, it is seen that the produced transition metal dichalcogenide fiber showed the intrinsic characteristics of the transition metal dichalcogenide, and the organic additive was removed by the heat treatment.

The method of producing a transition metal dichalcogenide fiber according to the present invention allows a spinning solution to have liquid crystallinity by a transition metal dichalcogenide, thereby fiberizing the transition metal dichalcogenide by simple wet spinning.

In addition, the method of producing a transition metal dichalcogenide fiber according to the present invention allows the spinning solution to have liquid crystallinity by the transition metal dichalcogenide, thereby fiberizing the transition metal dichalcogenide without use of a polymer or with assistance of a small amount of a polymer for viscosity adjustment, and thus, a transition metal dichalcogenide fiber which substantially expresses the inherent physical properties of the transition metal dichalcogenide as they are may be produced.

In addition, the method of producing a transition metal dichalcogenide fiber according to an exemplary embodiment of the present invention allows production of a transition metal dichalcogenide fiber having excellent orientation in which the transition metal dichalcogenide is oriented in an axis direction of the fiber, by shear stress applied during a wet spinning process.

Hereinabove, although the present invention has been described by specific matters, limited exemplary embodiments, and drawings, they have been provided only for assisting the entire understanding of the present invention, and the present invention is not limited to the exemplary embodiments, and various modifications and changes may be made by those skilled in the art to which the present invention pertains from the description.

Therefore, the spirit of the present invention should not be limited to the above-described exemplary embodiments, and the following claims as well as all modified equally or equivalently to the claims are intended to fall within the scope and spirit of the invention.

What is claimed is:

1. A method of producing a transition metal dichalcogenide fiber, the method comprising: spinning a spinning solution containing a transition metal dichalcogenide in a coagulation solution to obtain a transition metal dichalcogenide fiber, wherein the spinning solution has liquid crystallinity by the transition metal dichalcogenide.

2. The method of producing a transition metal dichalcogenide fiber of claim 1, wherein the liquid crystallinity is imparted to the spinning solution by adjusting one or more factors of the following Factors I) to III):
Factor I) number of transition metal dichalcogenide layers,
Factor II) average diameter of the transition metal dichalcogenide, and
Factor III) content of the transition metal dichalcogenide.

3. The method of producing a transition metal dichalcogenide fiber of claim 1, wherein the transition metal dichalcogenide is mono-layered.

4. The method of producing a transition metal dichalcogenide fiber of claim 1, wherein the transition metal dichalcogenide has a wave number difference between a peak by an in-plane vibration mode of each of a transition metal layer and a chalcogen layer and a peak by a vibration mode in a direction perpendicular to the chalcogen layer in a Raman spectrum of 18 cm⁻¹ or more.

5. The method of producing a transition metal dichalcogenide fiber of claim 1, wherein the transition metal dichalcogenide has an average diameter of an order of 10⁰ μm to an order of 10¹ μm.

6. The method of producing a transition metal dichalcogenide fiber of claim 1, wherein the spinning solution contains 0.5 wt % or more of the transition metal dichalcogenide.

7. The method of producing a transition metal dichalcogenide fiber of claim 1, wherein the spinning solution further contains a polymer additive which is a cellulose-based polymer, a polyoxyalkylene-based polymer, a polyacryl-based polymer, a polyvinyl-based polymer, a polysaccharide, or a mixture thereof.

8. The method of producing a transition metal dichalcogenide fiber of claim 7, wherein the spinning solution contains 5 to 20 wt % of the polymer additive.

9. The method of producing a transition metal dichalcogenide fiber of claim 1, wherein a cross-sectional shape of a nozzle from which the spinning solution is spun is controlled to adjust a cross-sectional shape of the transition metal dichalcogenide fiber.

10. The method of producing a transition metal dichalcogenide fiber of claim 9, wherein the cross-sectional shape of the nozzle has a circular shape, an oval shape, or a polygonal shape having rounded edges.

11. The method of producing a transition metal dichalcogenide fiber of claim 1, wherein the coagulation solution contains a polar solvent and a non-polar solvent having miscibility with the polar solvent.

12. The method of producing a transition metal dichalcogenide fiber of claim 1, wherein during the spinning, a shear stress is applied to the transition metal dichalcogenide fiber in the coagulation solution by rotation of the coagulation solution.

13. The method of producing a transition metal dichalcogenide fiber of claim 1, further comprising: heat-treating the fiber obtained by the spinning.

14. A transition metal dichalcogenide fiber wherein a transition metal dichalcogenide is laminated layer by layer, cross-sectionally.

15. The transition metal dichalcogenide fiber of claim 14, wherein the fiber has an apparent density of 0.5×10⁻⁶ to 5×10⁻⁶ g/cm³.

16. The transition metal dichalcogenide fiber of claim 14, wherein the fiber has liquid crystallinity.

17. The transition metal dichalcogenide fiber of claim 14, wherein the fiber has a diameter of 10 to 500 μm.

18. The transition metal dichalcogenide fiber of claim 14, wherein the fiber has an organic content of 10 wt % or less.

19. The transition metal dichalcogenide fiber of claim 14, wherein a transition metal of the transition metal dichalcogenide is one or more selected from the group consisting of Sn, Mo, W, Hf, W, Re, Ni, Zr, V, Ti, Nb, Ta, Tc, Co, Rh, Ir, Pd, and Pt, and a chalcogen element is one or more selected from the group consisting of S, Se, and Te.
